(19) United States
(12) Patent Application Publication
(10) Pub. No.: US 2011/0092257 A1
(43) Pub. Date: Apr. 21, 2011

(54) WIRELESS COMMUNICATION DEVICE

(76) Inventors: Steven D. Burt, South Jordan, UT (US); Louis Beach Bartell, Moab, UT (US)

(21) Appl. No.: 12/906,320

(22) Filed: Oct. 18, 2010

Related U.S. Application Data
(60) Provisional application No. 61/252,502, filed on Oct. 16, 2009.

(51) Int. Cl. H04M 1/18; H04W 88/02

(52) U.S. Cl. 455/575.1

(57) ABSTRACT

A personal communication device configured for use in geographic areas that have little to no wireless communication signal reception. The personal communication device includes a module that is configured to transmit and receive communication signals. The personal communication device further includes an inflatable portion that is filled with a gaseous substance that allows the inflatable portions to float. A tether is coupled to both the inflatable portion and to an object held to the earth, such that the altitude of the inflatable portion may be maintained at or near a reception altitude. Also coupled to the inflatable portion, or the tether, is a means for receiving and transmitting the wireless communication signals, the means for receiving and transmitting wireless communication signals being communicably associated with the module.

### CROSS-REFERENCE TO RELATED APPLICATIONS

This application claims the benefit of U.S. Provisional Application No. 61/252,502 filed Oct. 16, 2009, which is incorporated herein by reference in its entirety.

### BACKGROUND OF THE INVENTION

1. The Field of the Invention

Embodiments of the invention generally relate to devices, systems and methods for sending and receiving wireless communication. More particularly, embodiments generally relate to devices, systems and methods for communicating with wireless communication devices in a situation where typical wireless communication devices would be unable to access a wireless network or be out of range of wireless communication signals.

2. The Related Technology

Wireless communication devices, for example, cell phones, radios, and other similar wireless communication devices, may provide a convenient method of communication. In certain circumstances, however, and often when the convenience of communication is most needed, wireless communication devices may fail to operate or communicate properly because the wireless communication device is out of range of a wireless signal or is in a position where the wireless communication device is unable to transmit a wireless communication signal in such a manner that it may be received by another wireless communication device or network.

For instance, mountainous geographic regions often include canyons and other areas where the terrain may impede wireless communication signals from reaching a user's wireless communication device. For example, often times it is not possible to receive a sufficiently strong wireless cellular signal in a canyon or similar terrain, and therefore, a user of a cellular phone in a canyon is unable to communicate with individuals outside of the canyon.

Because a dependable cellular signal in mountainous terrain is typically unavailable, people wanting to communicate wirelessly often use other radio signals and radio devices instead of a cellular device that requires a cellular network. Radio communication devices may, however, need a clear line of sight between the radio communication devices to reliably send and receive radio communication signals. Thus, if a user of a radio communication device is located at the bottom of a slot canyon, for example, then the user's radio communication device may be unable to communicate with a second user's radio communication device located outside the slot canyon.

A dependable cellular signal, however, may be available at altitudes above those commonly attainable by persons in mountainous terrain, where a signal can be established between a cellular tower and a cellular device that requires a cellular network.

Due to the treacherous nature of mountain terrain, people recreating in these areas are often faced with emergency situations, such as severe weather, injury, or other circumstances that require communication with someone that may send assistance. Yet, as explained above, traditional wireless communication devices may not be able to reliably send a communication signal due to the lack of wireless communication signal reception, or due to the fact that the particular wireless communication device is not able to properly send or receive other wireless communication signals.

### BRIEF SUMMARY OF THE INVENTION

Embodiments of the invention generally relate to devices, systems and methods for sending and receiving wireless communication. More particularly, example embodiments generally relate to devices, systems and methods for communicating with wireless communication devices in a situation where conventional wireless communication devices would be out of range of wireless communication signals. Moreover, embodiments of the invention provide devices and systems that may automatically deploy a communication device in an emergency situation to allow search and rescue personnel to more readily locate those in need. Other embodiments of the invention provide a means for making conventional wireless communication devices available for use in areas where such devices would not otherwise be available. Still in other embodiments, the present invention generally relates to a system that allows for wireless internet communication over large distances.

In one embodiment, a personal communication device is configured for use in geographic areas that have little to no wireless communication signal reception. The personal communication device includes a module that is configured to transmit and receive communication signals. The personal communication device further includes an inflatable portion that is filled with a gaseous substance that allows the inflatable portion to float. A tether is coupled to both the inflatable portion and to an object held to the earth, such that the altitude of the inflatable portion may be maintained at or near a reception altitude. Also coupled to the inflatable portion, or the tether, is a means for receiving and transmitting the wireless communication signals, the means for receiving and transmitting wireless communication signals being communicably associated with the module.

In another embodiment, a broadband wireless internet communication system for use in remote geographic areas is disclosed. The wireless internet communication system includes a plurality of wireless internet modules positioned at a communicable distance from each other. Each wireless internet communication module includes an inflatable portion filled with a gaseous substance that allows the inflatable portion to float in air. The wireless internet communication module further includes a wireless internet repeater suspended from the inflatable portion, and a tether that is coupled between the inflatable portion and an object held to the earth such that the wireless internet repeater is positioned at a reception altitude. In one example, the wireless internet module includes a substation that has a powers source and a gaseous substance source.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS/APPENDIX

To further clarify the Summary above and other advantages and features of the present invention, a more particular description of the invention will be rendered by reference to specific embodiments that are illustrated in the appended drawings. It is appreciated that these drawings depict only typical embodiments of the invention and, therefore, are not to be considered limiting of its scope. The invention will be described and explained with additional specificity and detail through the use of the accompanying drawings in which:

FIGS. 1A and 1B illustrates one example of two personal communication devices configured to communicate in an environment that would otherwise prevent the two personal communication devices from communicating;

FIG. 2 illustrates one example implementation of the present invention using one personal communication device;

FIG. 3 illustrates another implementation of the present invention using one personal communication device;

FIG. 4 illustrates one example implementation of the present invention using more than one tether;

FIGS. 5A and 5B illustrate an example implementation of a long range wireless internet network; and

FIGS. 6A and 6B illustrate one example implementation of the present invention.

### DETAILED DESCRIPTION OF SOME EXAMPLE EMBODIMENTS

The embodiments described herein extend to devices, systems and methods for sending and receiving wireless communication. More particularly, example embodiments relate to devices, systems and methods for communicating with wireless communication devices in a situation where conventional wireless communication devices would be (i) unable to transmit signals to a wireless network or other wireless communication device or (ii) out of range of wireless communication signals.

Reference will now be made to the drawings to describe various aspects of exemplary embodiments of the invention. It is understood that the drawings are diagrammatic and schematic representations of such exemplary embodiments and do not limit the present invention. Similarly, no particular elements should be considered essential for all embodiments, nor should any elements be assembled or manufactured in any particular order or manner. Accordingly, no inference should be drawn from the drawings as to the necessity of any element. In the following description, numerous specific details are set forth in order to provide a thorough understanding of the present invention. It will be understood, however, to someone of ordinary skill in the art that the present invention may be practiced without these specific details. In other cases, general wireless communication techniques and principles are not herein described in detail in order to avoid unnecessarily obscuring aspects of the present invention.

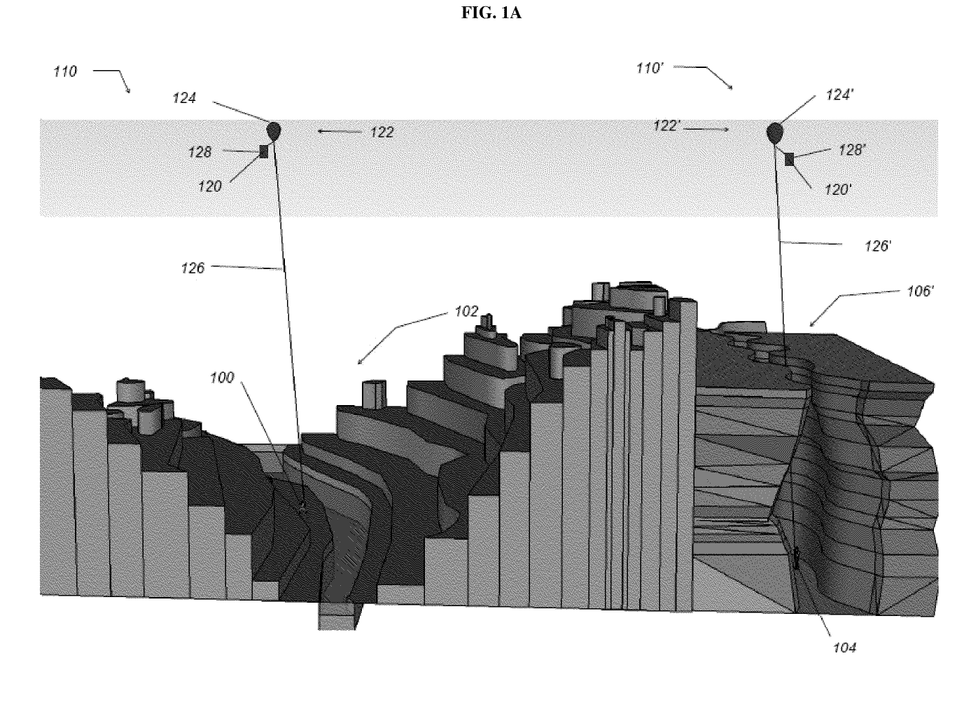

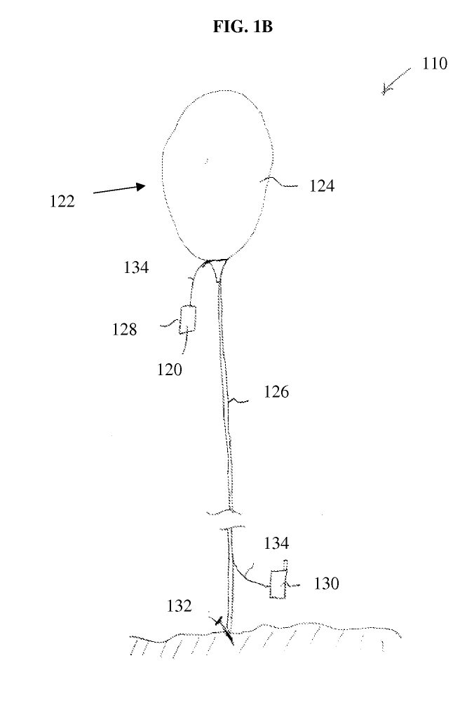

FIGS. 1A-1B (which may be collectively referred to as FIG. 1) and the following discussion are intended to provide a brief general description of exemplary devices and systems in which embodiments and aspects of the invention may be implemented. As illustrated in FIG. 1, a first user 100 is positioned in a canyon 102 while a second user 104 is positioned in a slot canyon 106. The first user 100 and the second user 104 may need or want to have wireless communication between them. Therefore, for example, the first user 100 and the second user 104 may each employ a personal communication system 110 and 110′, respectively, such that a wireless communication signal may be established. For ease of explanation, reference will be made herein to personal communication system 110, however, it will be understood that a similar discussion can be made for the personal communication system 110′ of the second user 104. Further, it will be understood that the same personal communication system can be used by each user.

As an overview, and as illustrated in the example embodiment of FIGS. 1A and 1B, and with reference to the personal communication system 110 of the first user 100, the personal communication system 110 may include an inflatable assembly 122 used to support a wireless communication device 120 and raise the same into the air. The inflatable assembly 122 includes an inflatable portion 124 that is filled with a gaseous substance such that the inflatable portion 124 is able to float and a retention device 128 adapted to receive the wireless communication device 120 and securely hold and support the wireless communication device 120 as the inflatable portion 124 raises the device 120 into the air.

The tether 126 is illustrated coupling the inflatable assembly 122 to the earth, such as through mount 132, to limit movement of the inflatable portion 124. The mount 132 can be temporary and removable by the user 100. The tether 126 can include a wire 134 that extends from the wireless communication device 120 to a communication module 130 usable by the first user 102 to speak, hear, text, email, or otherwise communicate with the second user 104 or some other third party. As such, the wire 134 communicably couples the wireless communication device 120 to the communication module 130 and facilitates communication of transmitted and received signals therebetween.

The wireless communication device 120 is an example of a means for transmitting and/or receiving wireless communication signals. The wireless communication device 120 may be, by way of example only, a signal repeater, cellular phone repeater, signal reflector, signal generator, signal amplifier, signal router, or any other wireless signal producing or receiving devices. It will be understood by those skilled in the art that there are various other devices and systems capable of performing the function of transmitting and/or receiving wireless communication signals. In at least one embodiment, the transmitting device is the user's regular cell phone.

As alluded to above, the wireless communication device 120 may also be configured to transmit the wireless communication signal via a wired 134 connection between the wireless communication device 120 and the module 130 that a user may hold. Specifically, in one embodiment a user may hold a module 130 that is configured to receive a wired communication signal. The tether 126 may include a wire 134, or have wire that is positioned adjacent to the tether 126 that runs substantially parallel to the tether 126, such that the module 130 is communicably connected by the wire 134 to the wireless communication device 120.

With continued reference to FIGS. 1A and 1B, by attaching or otherwise coupling the wireless communication device 120 to the inflatable portion 124, the inflatable assembly 122 holds the wireless communication device 120 at a reception altitude, or in other words, an altitude position that permits for wireless communication signals to be transmitted and received between the first user's 100 personal communication system 110 and the second user's 104 personal communication system 110′.

As mentioned in the above overview, the personal communication system 110 of the first user 100 includes the inflatable portion 124. The inflatable portion 124 may be configured to be inflated by, and retain, a gaseous substance such that the inflatable portion 124 may float upwards into the air. For example, the inflatable portion 124 may include a one-way valve that allows a user to inflate the inflatable portion 124 with the gaseous substance, but does not allow, or at least mostly blocks, the gaseous substance from escaping out of the inflatable portion 124.

The inflatable portion 124 may be made from a variety of gas tight materials, such as rubbers, plastics, nylon, Mylar foil, latex or other similar materials. In one embodiment, the inflatable portion 124 is a foldable material that may be reduced in size or folded to a compact form so that the inflatable portion 124 may be stored in a small space, for example a back pack. The inflatable portion 124 material may also include a reflective outer material that is able to reflect sunlight such that the inflatable portion 124 may be used as an emergency reflective device.

Although the inflatable portion 124 is illustrated in FIGS. 1A and 1B as having a substantially round or oval configuration in the inflated state, the inflatable portion 124 may take almost any form. In another example, the inflatable portion 124 configuration may include a plurality of flat areas that may be used to reflect light, or a wireless communication signal, in a plurality of directions that correspond to the plurality of flat areas. In particular, in one example embodiment, the inflatable portion 124 may suspend a separate reflective device that has a plurality of surfaces configured to reflect wireless communication signals in a broad range of directions.

Notwithstanding the material or configuration of the inflatable portion 124, the gaseous substance used to inflate the inflatable portion may vary from one embodiment to the next. In one example embodiment, the gaseous substance may be helium or a helium based mixture. Alternatively, the gaseous substance may be almost any gaseous substance that has a density lower than air such that the gaseous substance will cause the inflatable portion 124 to rise and float in air. For example, the gaseous substance is responsive to the differential of specific gravities of the atmosphere.

Referring back to FIG. 1B, the tether 126 may be made from a variety of materials, such as nylon string, nylon lines, or other similar materials. Preferably, the tether 126 material is a light weight material such that the amount of gaseous substance required to lift the tether is minimized. In one embodiment, the tether 126 material may at least partially be made from a material that may function as an antenna. In this embodiment, the tether 126 may serve as the means for receiving and transmitting wireless communication signals.

One embodiment of the personal communication system 110 or 110′ may include a kit that includes a small canister or chamber of pressurized gaseous substance such that the inflatable portion 124 may be inflated when needed. For example, the kit may include a pressurized canister or container of gaseous substance, the inflatable portion 124, the tether 126, and the wireless communication device 120 or means for receiving and transmitting wireless communication signals. The user may then use the contents of the kit to assembly and deploy the personal communication system 110 or 110′ as illustrated in FIGS. 1A and 1B.

Once the inflatable portion 124 is inflated with the gaseous substance, then the inflatable portion 124 is ready for deployment. Any time during deployment, the tether 126 may be coupled to the inflatable portion 124. The tether 126 acts as a securing line that holds the inflatable portion 124 at a substantially constant altitude. For example, and as shown in FIG. 1A, the first user 100 and the second user 104 may use the respective tethers to raise their respective inflatable portions 124 and 124′ to an altitude such that the wireless communication devices 120 and 120′ may be properly communicated.

For instance, FIG. 1A may represent a situation where the first user 100 and the second user 104 have radio communication devices. The radio communication devices may not be able to communicate unless they have a direct line of sight. Therefore, both the first user 100 and the second user 104 deploy the inflatable portion 124, 124′ of their personal communication systems 110 and 110′ and use the tethers 126, 126′ to achieve a reception altitude such that there is a direct line of sight between the wireless communication devices 120, 120′. Once there is a direct line of sight, the first user 100 and the second user 104 may communicate one with another.

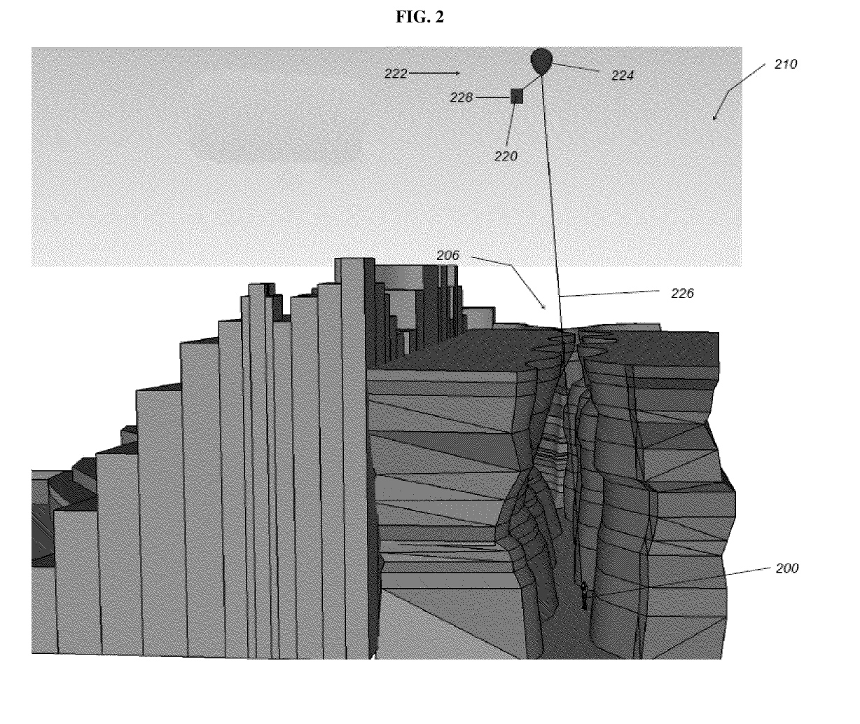

In another embodiment, and as mentioned above, the wireless communication device 120 or means for receiving and transmitting the wireless communication signal may be a cell phone repeater. As shown in FIG. 2, an individual user 200 may be located in a slot canyon 206, or other similar geographic terrain, where there is no cell phone signal reception. However, at the top of the slot canyon, there may be a sufficiently strong wireless cellular signal to allow communication via a cell phone or other wireless device. This may be true whether the wireless phone signal is a cellular signal, satellite signal, or any other type of wireless signal. Thus, the user may deploy the personal communication system 210 and use the tether 226 to raise an inflatable assembly 222, including an inflatable portion 224 and retention device 228, to position a cellular wireless phone repeater 220 held and supported by the retention device 228 up to the reception altitude. Once at the proper altitude, the individual user 200 may use a wireless phone as if he were located at the top of the slot canyon 206, instead of the bottom. It will be understood that the wireless phone repeater 220 can be connected to the inflatable portion 224 without the use of the retention device 228

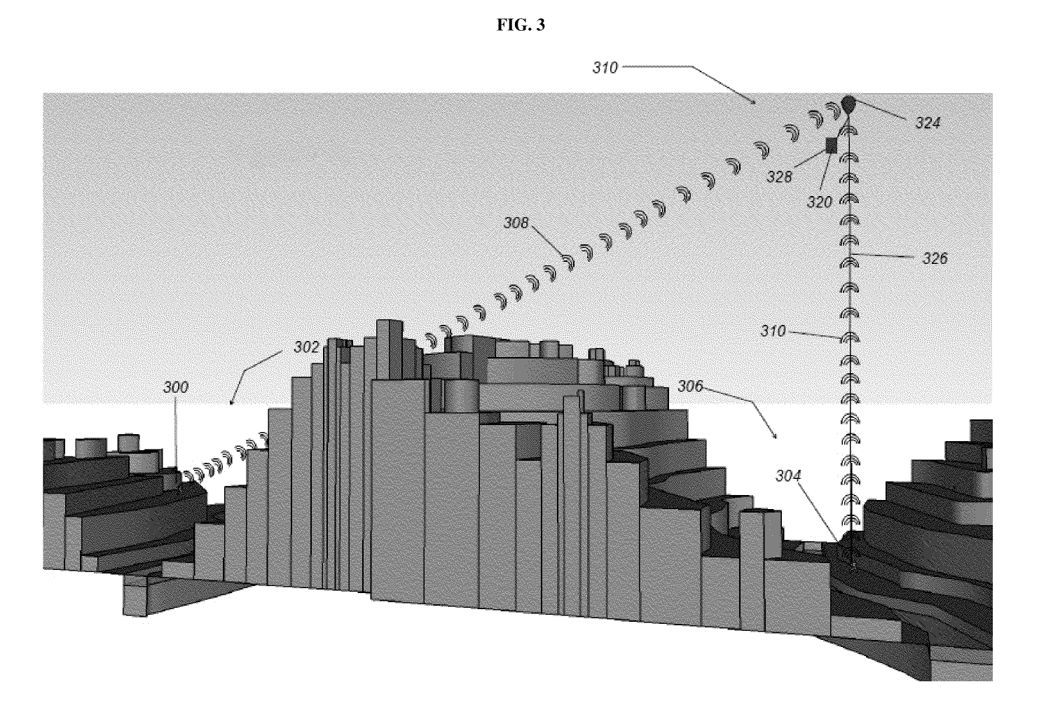

Another example of this is shown in FIG. 3 in which only one personal communication system 310 is used. For instance, in FIG. 3, a first user 300 and a second user 304 may be equipped with radio transceivers that require a direct line of sight to communicate properly. However, as shown in FIG. 3, the first user 300 may be located in a first canyon 302 and the second user 304 may be located in a second canyon 306 such that a direct line of sight is not possible. In this situation, the second user 306 may deploy the personal communication system 310, which may include an inflatable assembly 322 with an inflatable portion 324. A tether 326 cooperates with the inflatable portion 324 such that a retention device 328 positions a radio transceiver 320 at a reception altitude. In this way, radio signals 308 from the first user's 300 radio transceiver may have a direct line of sight with the radio transceiver 320, and the radio signals 308′ from the second user's 304 radio transceiver may also have a direct line of sight with the radio transceiver 320. Thus, the first user 300 and the second user 304 may wirelessly communicate.

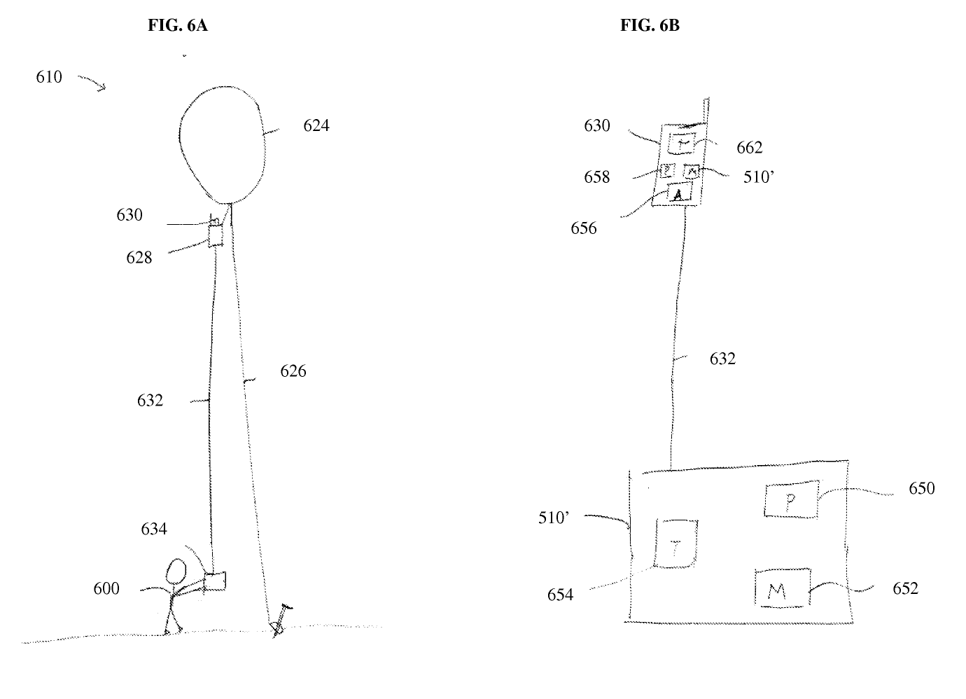

FIGS. 6A and 6B illustrate an addition embodiment a communication system 610. Communication system 610 includes an inflatable portion 624 coupled to a tether 626, which may be anchored to the ground. Suspended from the inflatable portion 624 is a retention device 630 that is specifically designed to secure a wireless phone 630. The wireless phone 630 is connected to a communication module 634 by way of a communication cable 632.

In use, the communication system 610 allows the user's 600 wireless phone 630 to be lifted to an altitude at which the wireless phone 630 has reception to a wireless network. The user 600 is then able to control the wireless phone 630 by using the communication module 634 as if the user 600 actually had the wireless phone 630 in his/her hand. For example, the communication module 634 may allow the user 600 to place a phone call, send and receive voice, send and receive text messages, and other features of the wireless phone 630. In one embodiment, the communication module 634 includes a keyboard and display such that the user 600 can control the wireless phone 630 in a similar fashion as if the user 600 actually was holding the wireless phone 630.

The communication module 634 and the wireless phone 630 are illustrated in greater detail in FIG. 6B. For example, the communication module 634 may include a processor 650, a memory means 652, and a transceiver 654. The memory means may include software, data, and other necessary information such that the communication module 634 can be configured to communicate with a particular wireless phone. Alternatively, the memory means 652 may include an application 656 that can be downloaded to the wireless phone 630. The application 656, once placed on the wireless phone 630, would allow the communication module 634 to effective communicate with the wireless phone 630.

Similarly, the wireless phone 630 may include a processor 658 and memory means 660 that allow the wireless phone to run the application 656 and process the communication signals generated by the communication module 634. The wireless phone 630 also includes a wireless transmitter 662 that can transmit the communication signals and information received from the communication module 634 over a wireless network.

The communication protocol between the communication module 634 and the wireless phone 630 can be any protocol that is currently known in the art. Further, in one embodiment the communication cable 632 is a USB cable that is easily connected to most wireless phones that are currently on the market. In other embodiments, the communication cable 632 may be any type of cable capable of carrying electronic communication signals.

Some example embodiments of the disclosure may be directed at use during emergency situations. Therefore, a variety of other features may be added to the personal communication system to assist with obtaining aid in an emergency situation. For example, the personal communication system may be equipped with a GPS type device that is able to broadcast an emergency distress signal along with the GPS coordinates of the device. Moreover, the GPS device, or similar device, may be able to be programmed with a user defined message. For example, it may broadcast a wireless message asking for medical aid, food, water, or other particulars needed in a rescue effort.

In addition to broadcasting emergency signals, the personal communication system may also include a series of features that make the inflatable assembly of the device more visible to search and rescue personnel. For example, the personal communication system may have a plurality of strobe lights suspended from the inflatable portion or coupled to the tether. Moreover, the inflatable portion may be made from a material that reflects radar at a particular frequency such that rescuers may use a radar signal to locate the device in an emergency situation.

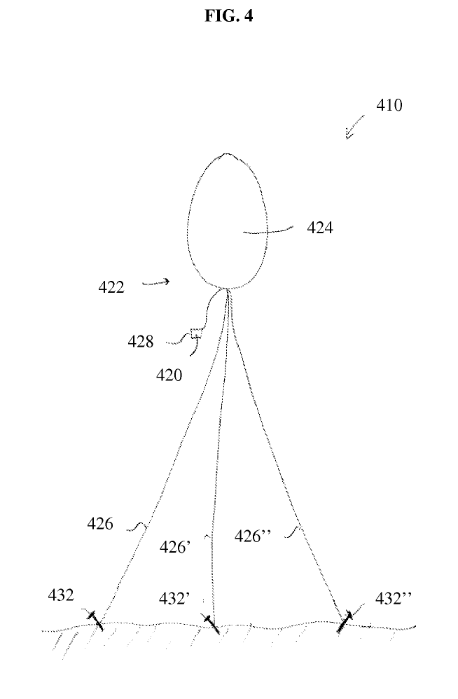

In some situations, for example military applications, it may be desirable to have a more permanent communication device. In this application, instead of using a single tether, a series of tethers may be coupled to the inflatable portion such that the inflatable portion is more securely held to the ground. FIG. 4, for example, shows a communications system 410 that includes an inflatable assembly 422 with an inflatable portion 424 and a wireless communication device 420 that is coupled to the inflatable portion 424 with a retention device 428. However, in this embodiment, the communications system 410 includes three tethers 426, 426′, and 426″ that may be held to the ground by three corresponding mounts 432, 432′ and 432″. The mounts 432, 432′ and 432″ may be configured in a substantially triangular configuration to hold the inflatable portion 424 at a more constant altitude, even in windy conditions. Of course, in other embodiments, more or less than three tethers may be used.

In other applications, it may be desirable for the personal communication system to deploy automatically. In one example implementation, the communication system is associated with an aircraft, such as an airplane or helicopter. The communication system may then be configured to deploy if the aircraft experiences an emergency situation. For example, the communication device may be configured to automatically deploy upon a sudden impact, at a certain altitude, or simply by the pilot pressing a button. In this way, the communication device may lift to an altitude to broadcast an appropriate emergency signal, which may include GPS coordinates of the communication device. In one example embodiment, the communication device may be configured to record GPS locations and elevations such that the information may be used in rescue efforts, as well for investigative purposes. The communications device may also be attached to, or incorporated with, the ‘black box’ located on most aircraft such that rescuers and investigators can more easily locate the black box after an aircraft accident. Such attachment to, or incorporation with, the black box may include a means of transferring and storing the information contained in the black box such that the communication device itself contains such information in a recoverable format and/or is equipped with a means of broadcasting said information wirelessly.

The personal communication device described above may include various sources of power. For example, the personal communication device may be associated with a battery power source, solar cells, wind generators, or other means of creating and storing power.

Moreover, as described above, the personal communication device may be able to communicate over a wide range of signals or protocols. For example, a personal communication device that uses cellular signals may be configured to communicate with SMS or MMA, or any other cellular protocol. Likewise, the personal communication device may have a controller associated with the device such that the user may select the type of signal and protocol to use. Moreover, the personal communication device may be configured to automatically recognize an available signal and protocol, and then communicate using that protocol.

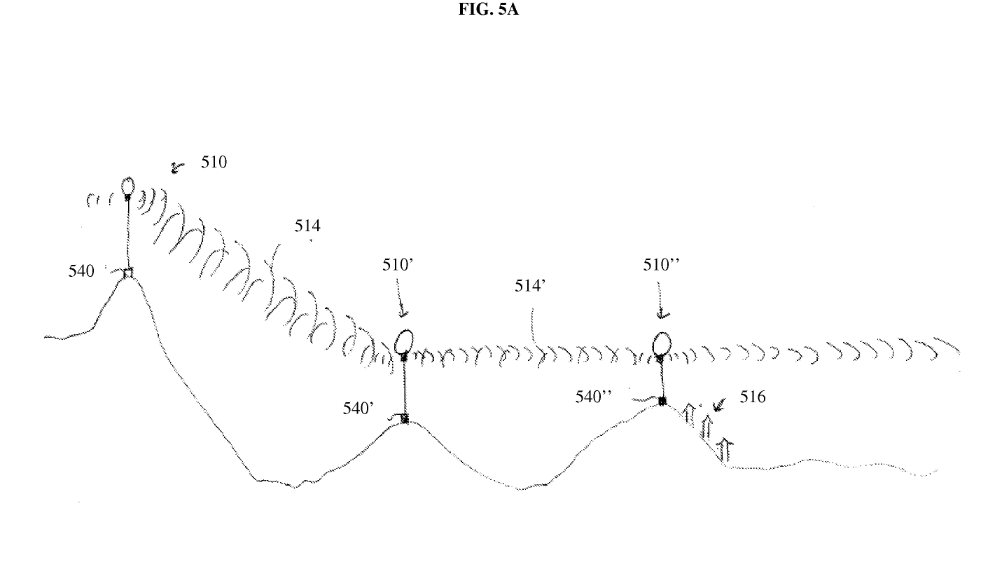

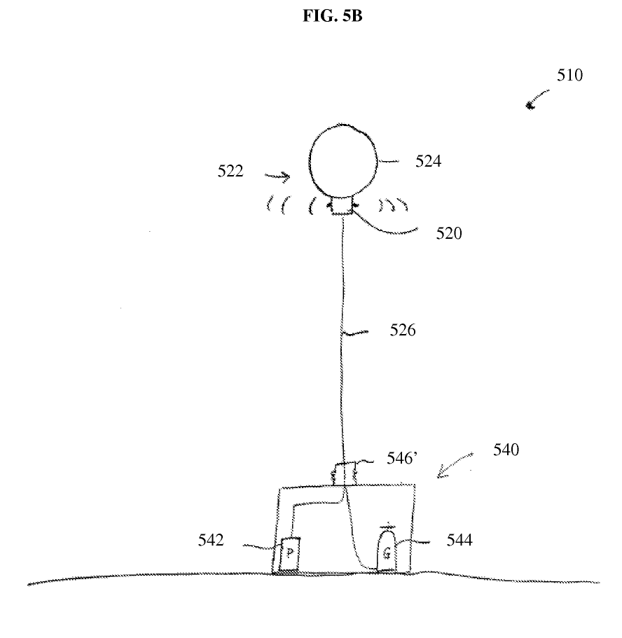

In addition to providing a means for personal communication in emergency or other situations, embodiments of the invention may also relate to transmitting a wireless signal across large areas of land. For example, and as illustrated in FIG. 5A, embodiments of the invention provide an efficient way to provide a wireless internet signal to remote geographic areas, thus avoiding the cost associated with running hundreds of miles of communications cable.

As an overview, a wireless internet system may be created using a plurality of wireless internet modules 510, 510′ and 510″ that includes substations 540, 540′ and 540″, respectively. Each of the wireless internet modules 510, 510′, and 510″ are positioned at a reception distance from another wireless internet module, as shown in FIG. 5A. Specifically, for example, the wireless internet module 510 is positioned at a reception distance from wireless internet module 510′ such that the wireless internet signals 514 may be transmitted and received between wireless internet module 510 and wireless internet module 510′. Wireless internet module 510″ is similarly positioned with respect to wireless internet module 510′. Once the wireless internet signal reaches a desired geographic location, such as the village 516, the wireless internet signal may be converted to a wired signal and sent to the substation 540′. The substation 540′ may then coordinate the disbursement of the internet signal in a defined proximity around the substation, for example, the village 516. Alternatively, the wireless internet signal could simply be converted to a local wireless signal that is meant to be broadcast only in a defined proximity around the substation 540′.

One example of the wireless internet module is illustrated in more detail in FIG. 5B. As shown in FIG. 5B, the wireless internet module includes an inflatable assembly 522 with an inflatable portion 524 filled with a gaseous substance that allows the inflatable portion 524 to float. Attached or otherwise coupled to the inflatable portion 524 is a wireless internet repeater 520 that is configured to send and receive wireless internet signals. A tether 512 may couple between the inflatable assembly 522 and a substation 540 that is located on the ground.

Due to the fact the wireless internet module 510 has a more permanent structure; the inflatable assembly 522 may be tethered to the substation using three, four, five, or more tethers 526. Additionally, the wireless internet module 510 may require a power source 542. The substations may include any variety of power sources 542, such as a battery, a rechargeable battery, solar power, gas generator, or simply a connection to a power grid.

Moreover, because the gaseous substance is bound to leak at some leakage rate out of the inflatable portion 524, the wireless internet module 510 may be configured with gas source 544 that is operatively connected to the inflatable portion 524 while the inflatable portion is in the air. In one example, a measurement device 546 is associated with one or more tethers 526 to measure the force at which the inflatable portion 524 is pulling on the tethers 526. If the force drops below a predetermined threshold, then the measurement device 546 triggers the gas source 544, such as a pressurized gas tank, that sends pressurized gas to the inflatable portion 524 such that the inflatable portion 524 is inflated with additional gaseous substance. In another embodiment, a leakage rate may be calculated such that the gas source 544 is always inflating the inflatable portion 524 at a rate at least equal to the leakage rate. In one example embodiment, the gas source 544 is connected to the inflatable portion 524 with at least one line of flexible tubing. In one embodiment, the flexible tubing also acts as a tether 526.

By strategically placing a plurality of wireless internet modules, a wireless internet communication system may be created and bring the internet, and other wireless communication, to areas of the world that would otherwise have no access to the internet. Moreover, wireless internet modules may be configured to float, such that a wireless internet signal may be communicated across expansive bodies of water as well.

The invention is susceptible to various modifications and alternative means. Specific examples have been shown by way of example in the drawings and are described in detail herein. It should be understood, however, that the invention is not to be limited to the particular devices or methods disclosed. To the contrary, the invention is to cover all modifications, equivalents, and alternatives falling within the spirit and scope of the claims.

We claim:

1. A personal communication system for use in geographic areas with little to no wireless communication signal reception, the personal communication system comprising:
a module configured to transmit and receive communication signals;
an inflatable assembly responsive to the differential of specific gravities of the atmosphere and a gaseous substance associated with the inflatable assembly;
a tether coupled to both the inflatable assembly and to an object held to the earth such that the inflatable assembly portion is positionable at or near a reception altitude at which wireless communication signals may be received; and
a means for receiving and transmitting the wireless communication signals that is operatively associated with the inflatable assembly such that the means for receiving and transmitting are positioned at the reception altitude, wherein, the means for receiving and transmitting the wireless communication signals is communicably associated with the module.

2. The personal communication system as recited in claim 1, wherein the gaseous substance is helium.

3. The personal communication system as recited in claim 1, wherein the means for receiving and transmitting the wireless communication signals is a cellular phone repeater.

4. The personal communication system as recited in claim 1, wherein the means for receiving and transmitting the wireless communication signals is a radio antenna.

5. The personal communication system as recited in claim 4, wherein the radio antenna is also the tether.

6. The personal communication system as recited in claim 1, further including a GPS device that can determine the GPS coordinates of the personal communication device and broadcast the GPS coordinates in a wireless signal.

7. The personal communication system as recited in claim 1, further including one or more light signals coupled to the inflatable portion.

8. The personal communication system as recited in claim 1, wherein the inflatable portion is made from reflective material.

9. The personal communication system as recited in claim 1, wherein the inflatable portion is associated with a storage tank of the gaseous substance such that the inflatable portion automatically inflates based a single condition precedent.

10. The personal communication system as recited in claim 1, wherein the personal communication system is configured to automatically deploy and automatically generate communication signals.

11. The personal communication system as recited in claim 10, wherein the personal communication system automatically deploys upon one or more of the following events: sudden impact, falling below a specified impact, or the pressing of an emergency trigger.

12. The personal communication system as recited in claim 11, wherein the personal communication system is associated with a black box located in an aircraft.

13. A broadband wireless internet communication system, the broadband wireless internet system comprising:
a plurality of wireless internet modules, each wireless internet module positionable within an operative proximity of at least one other wireless internet module to transmit and receive wireless internet signals between the plurality of wireless internet modules, each wireless internet module, comprising;
an inflatable assembly including an inflatable portion filled with a gaseous substance, the gaseous substance having a density lighter than air;
a wireless internet repeater suspended from the inflatable portion and configured to send and receive wireless internet signals;
a tether coupled between the inflatable portion and an object held to the earth such that the wireless internet repeater is positioned at a reception altitude; and
a substation, comprising:
a source of power that is electrically connected to the wireless internet repeater; and
a pressurized chamber filled with the gaseous substance, the pressurized chamber operatively associated with the inflatable portion to ensure the inflatable portion has a minimum volume of the gaseous substance.
